(19) United States
(12) Patent Application Publication
(10) Pub. No.: US 2010/0026452 A1
(43) Pub. Date: Feb. 4, 2010

(54) DEPOSIT BOX UNIT, LOGISTICS SYSTEM AND METHOD FOR OPERATING THE DEPOSIT BOX UNIT

(75) Inventors: Stefan Wilms, Koln (DE); Keith Ulrich, Bonn-Oberkassel (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/526,378

(22) PCT Filed: Feb. 12, 2008
(86) PCT No.: PCT/EP08/01052

§ 371 Date: Aug. 7, 2009

(30) Foreign Application Priority Data
Feb. 16, 2007 (EP) 07003319.6

(51) Int. Cl. G06F 7/04

(52) U.S. Cl. 340/5.73

(57) ABSTRACT

There is provided a deposit box facility for depositing objects into and/or picking up objects from the deposit box facility. An exemplary deposit box facility comprises an audio playback device and a processor that is adapted to process audio data played back by the audio playback device. The processor may also be adapted to identify an object present in the deposit box facility on the basis of the information acquired from the audio data. The exemplary deposit box facility also comprises a device that is adapted to ascertain compartments of the deposit box facility in which there are no objects and to make a comparison of dimensions of the ascertained free compartments of the deposit box facility with object dimensions that have been received as part of the information acquired from the audio data.

### CROSS REFERENCE TO RELATED APPLICATIONS

Pursuant to 35 U.S.C. §371, this application is the United States National Stage Application of International Patent Application No. PCT/EP2008/001052, filed on Feb. 12, 2008, the contents of which are incorporated by reference as if set forth in their entirety herein, which claims priority to European (EP) Patent Application No. 07003319.6, filed Feb. 16, 2007, the contents of which are incorporated by reference as if set forth in their entirety herein.

### BACKGROUND

Electronic deposit box facilities and methods for their operation are known and described by way of an example in the following patent specifications of Deutsche Post AG: EP 1 408 801, EP 1 408 802, EP 1 409 160, EP 1 421 537 und EP 1 438 641.

### SUMMARY OF THE INVENTION

An exemplary embodiment of the present invention relates to a deposit box facility in which an object can be placed, stored and from which said object can be picked up.

Exemplary embodiments of the present invention may also relate to a logistics system comprising the deposit box facility and to a method for operating the deposit box facility.

A deposit box facility according to an exemplary embodiment of the present invention may make it easier to pick up objects deposited there.

A deposit box facility according to an exemplary embodiment of the present invention may receive data from an audio playback device. The deposit box facility may process the data played back by the audio playback device, and may identify at least one object present in the deposit box facility on the basis of the information acquired from the audio data.

In this manner, the deposit box facility is configured in such a way that, in an especially preferred manner, it can be integrated into a logistics system.

An identification code is detected when at least one object is deposited into the deposit box facility.

The identification code is associated with the object or objects that are meant to be delivered to a user.

According to an exemplary embodiment of the present invention, every single object is associated with an identification code that unambiguously identifies it, and several objects meant to be delivered to a user are associated with a shared identification number.

The object or objects can be, for example, mailpieces or merchandise meant for delivery to the user.

In an especially preferred embodiment, the deposit box facility according to an exemplary embodiment of the present invention is configured as an electronic parcel deposit box facility.

However, is it likewise possible to use the deposit box facility according to an exemplary embodiment of the present invention as a vending machine that allows merchandise deposited for a user to be picked up.

A preferred exemplary embodiment of the deposit box facility includes a control unit that generates a control signal.

An advantageous refinement of an exemplary embodiment of the present invention provides that the control unit generates or transmits a control signal to a locking mechanism for opening a door associated with the object on the basis of a transmitted compartment identifier.

An exemplary embodiment of the invention provides that, in at least one compartment of the deposit box facility, there is a compartment-detection device that detects an audio playback device situated in the compartment and acquires data from the audio playback device. The compartment-detection device may transmit the data read out of the audio playback device to the data processing unit, whereby the data processing unit has a storage device that stores the data in order to identify the compartment in question.

A refinement of an exemplary embodiment of the present invention is characterized in that additional information is associated with the audio data.

It is especially advantageous for the audio data to contain an audio barcode.

An exemplary embodiment of the invention provides that a registered or non-registered user of the deposit box facility is informed about a scheduled, pending or effectuated deposition of an object, especially a mailpiece.

The user can be informed in many different ways. It is advantageous for the notification itself to contain audio data or for audio data to be transmitted—if applicable in addition to a notification that has been made via a different modality.

An exemplary embodiment of the invention provides that the audio data is transmitted in such a way that it is relayed to a voice box of the user.

The audio data can be forwarded directly to an e-mail inbox, for example, using a suitable control code.

Exemplary embodiments of the invention provide that the audio data is transmitted by a device of the user (user device) to the deposit box facility.

Advantageously, the transmission is made as a direct acoustic signal, for example, via a built-in loudspeaker of the user device.

The user device is, for example, a mobile phone, a personal digital assistant, a computer—preferably a laptop computer—or another medium that is suitable for storing and/or reproducing information, for example, an audio player such as, for example, an MP3 player.

It is possible for the audio data to directly contain information about the association of the object.

However, it is especially advantageous to provide an audio barcode.

An audio barcode is, for example, an inaudible, high-frequency component of the audio signal that, within the scope of an exemplary embodiment of the present invention, contains information such as an identifier that identifies the object, optionally control information and, in certain embodiments, also information to identify the user, whereby the audio barcode can be played back via a built-in loudspeaker in a mobile terminal device.

Advantageously, the deposit box facility contains at least one microphone to receive the audio data.

The previously received audio data is then evaluated in the deposit box facility.

The information acquired through the evaluation is then shown on the display of the terminal device. In this manner, the user of the terminal device can listen in order to receive audio data that is of interest to him. Moreover, the information contained in the audio barcode can also contain information for controlling the deposit box facility.

A refinement of an exemplary embodiment of the present invention provides for the audio data to be embedded as an audio watermark into an audio signal.

It is advantageous for the additional information to be encrypted in such a way that it can be decrypted with a key that is present in the receiving device, and for the audio watermark to contain the encrypted additional information.

In a preferred exemplary embodiment of the invention, a data signal is incorporated into an audio signal (sound signal). Preferably, the audio signal is incorporated as an inaudible signal in the form of an audio watermark.

The audio watermark is a data signal inside an audio signal that, due to the physio-acoustic properties of human hearing, is essentially inaudible. Audio watermarks are generated through modifications of the audio signal that is essentially inaudible to the human ear and these modifications can be electronically detected and evaluated. The watermark technology is capable of embedding additional information into an audio signal, and this additional information extracts, for example, identification information and/or control information from the signal, thereby providing, for example, authorization for a shipment to be removed.

Exemplary embodiments of the invention comprise the generation of an audio signal that is inaudible to humans. The inaudibility of the audio signal is achieved, for example, by selecting the frequency range or by embedding said audio signal into another signal, for example, a spoken message—preferably in the form of an audio watermark.

Advantageously, the audio data is played back by a loudspeaker of a user device in the form of an audio signal and can be received by a suitable receiving device—especially by a microphone or a sensor—of the deposit box facility.

The audio data and thus preferably also the audio signals generated on its basis—preferably in a mobile user unit, for example, a mobile phone or a mobile digital assistant—can contain various items of information according to an exemplary embodiment of the present invention.

It is particularly advantageous for the audio data to contain identification information.

The identification information serves, for example, to identify the user, or else the object or objects to be picked up. Furthermore, it is possible to use the identification information to associate users with user groups. For example, different user groups can be granted different rights for actions at the deposit box facility.

In order to facilitate the operation of the deposit box facility, it is especially advantageous for the audio data to be associated with control information.

In an especially practical manner, this is done in that the control information is contained in the audio data or can be extracted from said audio data, if applicable, through decryption or through some other processing step.

This control information makes it possible to even further automate operating procedures of the deposit box facility.

This is done, for example, in that the audio data is forwarded to a voice box.

This can be done, for example, in that the audio data is generated during a processing procedure of the object—for example, during a processing procedure in a mail or package center or when it is deposited in the deposit box facility.

The generated audio data is preferably forwarded to a voice box.

The voice box is a memory for speech or other acoustic signals, including the audio data according to the invention. The voice box offers access possibilities via the phone network. Such a network can be, for example, analog or digital, and configured, for example, as ISDN, GSM, UMTS or Voice over IP.

The voice box can also be an answering machine or other recording device. However, it is equally advantageous for the function of the voice box to be provided by a network operator or service provider. A voice box makes it possible to leave an acoustic message for a user—preferably using the audio data according to the invention.

When the voice box is provided by the network operator or service provider, the messages are stored centrally by the provider of this service. The messages can then be retrieved from any phone connection by calling a certain phone number and entering a code that protects against the messages being listened to by unauthorized persons.

Preferably, digital, compressed audio data such as, for example, audio files in the MP3 format, is used as the source for the playback of the audio data since, due to their reduced data volume, they are easy to obtain electronically.

When an audio watermark is used, it is advantageous for the audio watermark to be robust against compression of the audio data. For this purpose, the person skilled in the art can turn to technologies known from other technical fields, especially the music industry.

In order to make it easier for a non-registered user to pick up the object, a refinement of the invention comprises a method for delivering a shipment to an electronic deposit box facility.

This method may comprise the following steps:
depositing the shipment into a compartment of the electronic deposit box facility;
transmitting the audio data to the user and/or to a mobile user unit that he/she can use—for example, a mobile phone or another device that is suitable for playing back audio data;
picking up the shipment at the deposit box facility by a person, whereby
   at least the identifier associated with the recipient of the shipment is recorded,
   the identifier associated with the recipient of the shipment is compared to the identifier stored for occupied compartments, and
   the deposited shipment is released from a compartment if the result of the comparison indicates that the identifier associated with the recipient matches the identifier stored for the compartment in question.

When an ordered shipment is placed into the Packstation, aside from an SMS and e-mail notification, it is also possible to send audio data, for example, in the form of an audio message, to the mobile phone voice mailbox of the recipient. This individual notification has a one-time code, in the form of a sound sequence, that provides authorization for the Packstation to be opened. The user takes his/her mobile phone to the Packstation, calls his/her voice mailbox and plays back the audio message. The Packstation recognizes the sound sequence and releases the compartment containing the shipment.

The deposit box facility according to an exemplary embodiment of the present invention can be used by registered as well as by non-registered users.

In order to make it easier for a non-registered user to use the facility, it may be advantageous to employ one or both of the following variants:
The user provides his/her mobile phone number or e-mail address to the sender, already at the time of placing the order. The sender adds an unambiguous identifier (as a rule, the barcode on the address sticker) of the shipment to this data and transmits it to the IT system of the deposit box facility or of the logistics operator.
The user enters the unambiguous identifier (e.g. the barcode on the prepaid postage indicium) as well as the mobile phone number or e-mail address of the recipient on the Internet page of the logistics operator or of the deposit box facility. It is also conceivable to do this by phone, e-mail or SMS.

The deposit box facility according to an exemplary embodiment of the present invention serves for depositing objects into and picking up objects from compartments of said deposit box facility, whereby each compartment has a door that can be locked by a locking mechanism. The locking mechanism is in communication with a control unit, which is adapted to actuate the locking mechanism via control signals. The control unit, in turn, is in communication with a data processing unit, whereby an unambiguous compartment identifier is associated with each compartment. Moreover, the data processing unit can be queried so as to provide information about which compartments contain an object.

An exemplary embodiment of the present invention comprises a logistics system for transporting a shipment along a transportation route within a postal distribution network.

Within the scope of an exemplary embodiment of the present invention, the term logistics system is to be understood in a broad sense. In particular, it encompasses systems having the requisite means and devices to carry out the transportation of shipments from an originating point to a destination point along a transportation route within a postal distribution network. Moreover, the deposit box facilities according to the invention are part of the logistics system.

The originating point is, for example, a warehouse or drop-off location, for instance, of an object that is going to be sold or that has been sold.

According to an exemplary embodiment of the present invention, the deposit box facility has a central facility-detection device that is in communication with the data processing unit. The central facility-detection device is adapted to recognize at least one audio playback device situated in a defined area around this-detection device, as well as to acquire data from the audio playback device. The data read out of the audio playback device contains at least the dimensions of the object that is associated with a given audio playback device.

In a preferred exemplary embodiment of the invention, the central facility-detection device is adapted to simultaneously detect several audio playback devices situated in a defined area around this facility-detection device. In this case, the control unit likewise may be adapted to simultaneously generate and/or transmit several control signals to the locking mechanism so that the doors of the free compartments in question can be opened with the transmitted compartment identifiers.

In another exemplary embodiment of the invention, the control unit is adapted to consecutively generate and/or transmit several control signals to the locking mechanism so that the doors of the free compartments in question can be opened with the transmitted compartment identifiers.

In a preferred exemplary embodiment of the invention, a compartment-detection device is also arranged in at least one compartment of the deposit box facility and it is adapted to recognize an audio playback device situated in the compartment and to acquire data from the audio playback device. The compartment-detection device is adapted to transmit the data read out of the audio playback device to the data processing unit, whereby the data processing unit is adapted to store the data in order to identify the compartment in question.

An exemplary embodiment of the present invention also comprises a method for operating a deposit box facility in which objects are placed into compartments of the deposit box facility, whereby a control unit for opening the door of a compartment transmits a control signal to a locking mechanism of the compartment. Moreover, in order to identify the compartments, the dimensions of the compartment in question are stored in a data processing unit.

According to an exemplary embodiment of the present invention, at least one audio playback device is recognized in a defined area around a facility-detection device, and data is read out of the audio playback device.

An exemplary embodiment of the present invention likewise comprises the fact that the audio playback device emits an audio signal containing the audio data and that this audio signal is detected by the deposit box facility.

The person skilled in the art can thus use push functions as well as pull functions.

The data received from the audio playback device contains, for example, the dimensions of an object that is to be deposited into the deposit box facility.

The audio data acquired by the audio playback device is transmitted to the data processing unit. The data processing unit then ascertains the compartments in which there are no objects and makes a comparison of the dimensions of the ascertained free compartments of the deposit box facility with the object dimensions that have been received from the audio playback device. On this basis, a free compartment in the deposit box facility is ascertained whose dimensions are larger than the dimensions of the object.

In a process step, the compartment identifier of the ascertained free compartment is determined, and this is transmitted to the control unit. The control unit receives the compartment identifier and then generates a control signal. The control signal is transmitted to the locking mechanism of the compartment together with the received compartment identifier, whereby the control signal triggers the opening of the compartment door.

In a preferred exemplary embodiment, the central facility-detection device simultaneously detects several audio playback devices situated in a defined area around this-detection device and reads them out. The control unit generates, preferably likewise simultaneously, several control signals and/or transmits them to the locking mechanisms so that the doors of the free compartments in question can be opened together with the transmitted compartment identifiers.

If the comparison of the dimensions of the object with the dimensions of the free compartments shows that no free compartment has dimensions that are larger than the dimensions of the object, then the data processing unit preferably generates a signal that is transmitted by the data processing unit to an operating unit of the deposit box facility. The signal can be converted by the operating unit, for example, on a display means, into an optical and/or acoustic message.

In another exemplary embodiment of the invention, the control unit preferably consecutively generates several control signals and/or transmits them consecutively to the locking mechanism so that the doors of the free compartments in question can be opened with the transmitted compartment identifiers. Preferably, the sequence of the transmitted control signals is dependent on the dimensions of the compartments. For example, a control signal is transmitted to a compartment having smaller dimensions before a control signal is transmitted to a compartment having comparatively larger dimensions.

A method according to an exemplary embodiment of the present invention also provides that a compartment-detection device in at least one compartment of the deposit box facility detects an audio playback device situated in the compartment and reads out data from the audio playback device. The compartment-detection device transmits the data that has been read out of the audio playback device to the data processing unit, whereby the data processing unit stores the data in a storage device in order to identify the compartment in question.

This exemplary embodiment has the advantage that information belonging to objects can be acquired at a deposit box facility quickly and error-free. In particular, the dimensions that pertain to an object to be deposited into the deposit box facility and that are stored in an audio playback device can be used to ascertain free compartments into which the object in question will fit. If the transponders of the objects are detected at the same time, all of the compartments required for depositing the objects can be very quickly opened for the user of the deposit box facility.

If an exemplary embodiment of the deposit box facility is selected in which another-detection device for reading in audio data is situated in each compartment, this has the advantage that the occupation status of the compartments can be ascertained at any point in time. Furthermore, via the compartment-detection devices, data relating to objects that have already been associated with a compartment and placed into it can be systematically read out of the audio playback device.

Another advantage of an exemplary embodiment of the present invention is that business customers can place several shipments into one compartment, whereby this is recognized by the deposit box facility and there is no need for the deliverer to enter this information. In this manner, it is likewise ensured that, when the customer picks up the shipments, a proof of delivery can be generated for all of the shipments from one compartment.

Moreover, shipments that belong together (so-called packing unit shipments) can be placed together into the compartment on the basis of the automatic detection, and they can also be released together when they are picked up.

### BRIEF DESCRIPTION OF THE DRAWINGS

The figures show the following:

FIG. 1 is a perspective view of a deposit box facility according to an exemplary embodiment of the present invention for depositing and picking up objects;

FIG. 2 is a block diagram of an operating unit of a deposit box facility according to an exemplary embodiment of the present invention.

### DETAILED DESCRIPTION OF SPECIFIC EMBODIMENTS

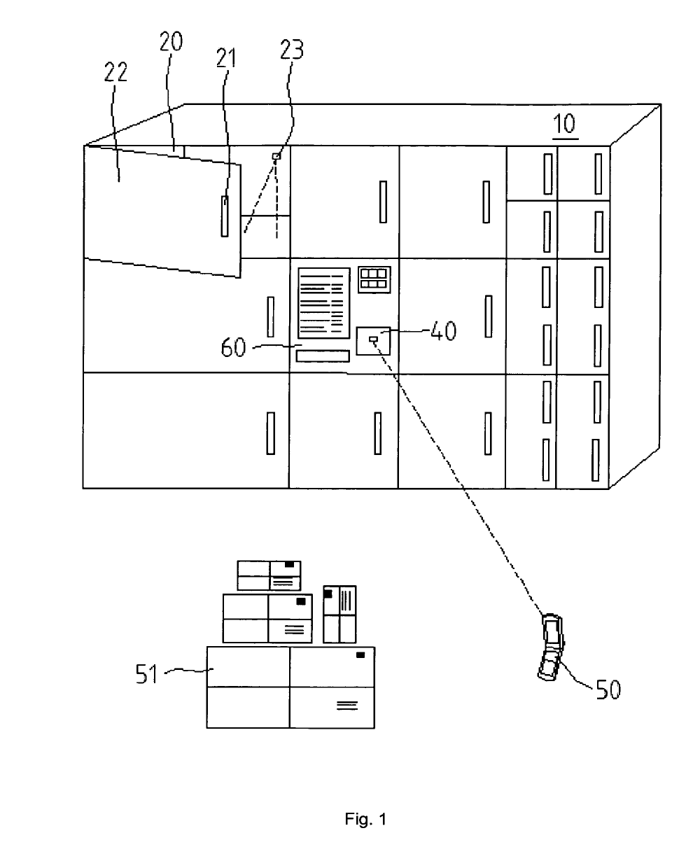

The deposit box facility shown in FIG. 1 is a deposit box facility according to an exemplary embodiment of the present invention on the basis of which the features of the invention and possible additional configurations are explained.

The deposit box facility 10 has several compartments 20 that can each be locked with a door 22. The doors can be conventional panels that can be manually swiveled by an operator. Moreover, they can be doors with which a usually electronic actuation of a mechanism causes the compartment door to open and close automatically, without an operator having to take manual action.

A compartment door 22 normally has a locking mechanism 21 with which the compartment can be locked to protect against unauthorized access. In FIG. 1, this locking mechanism 21 is arranged on the doors in order to simplify the depiction. The essential part of the locking mechanism, however, can also be situated on the compartment body itself, so that a door latches, for example, only into a locking mechanism of the compartment or is released by it again. The locking mechanism can have, for example, springs that make a compartment door swing open automatically as soon as a control unit sends the signal to the locking mechanism to open a compartment. The compartment door can be pushed closed against the spring force, for example, by an operator.

Preferably, the deposit box facility 10 has several compartments of different sizes. FIG. 1 shows three different compartment sizes by way of an example, but additional size variants can also be provided. The dimensions of the compartments can vary as desired, so that not only the width or height, but also the depth of a compartment can be configured differently.

The deposit box facility also has an operating unit 60 with which the depositing and pick-up procedures at the deposit box facility can be carried out. The operating unit preferably has a display device such as a monitor as well as a device to acquire information at the deposit box facility. The monitor serves for communication with users of the deposit box facility. Keypads, touch screens, barcode scanners or other reading devices, for example, can be used in order to acquire information. Furthermore, the occupation status of individual compartments and/or messages can be displayed to an operator via the monitor.

When an ordered shipment is placed into the Packstation, if desired, aside from an SMS and e-mail notification, it is also possible to send an audio message to the mobile phone voice mailbox of the recipient. This individual notification has a one-time code, in the form of a sound sequence, that provides authorization for the Packstation to be opened. The user takes his/her mobile phone to the Packstation, calls his/her voice mailbox and plays back the audio message. The Packstation recognizes the sound sequence and releases the compartment containing the shipment.

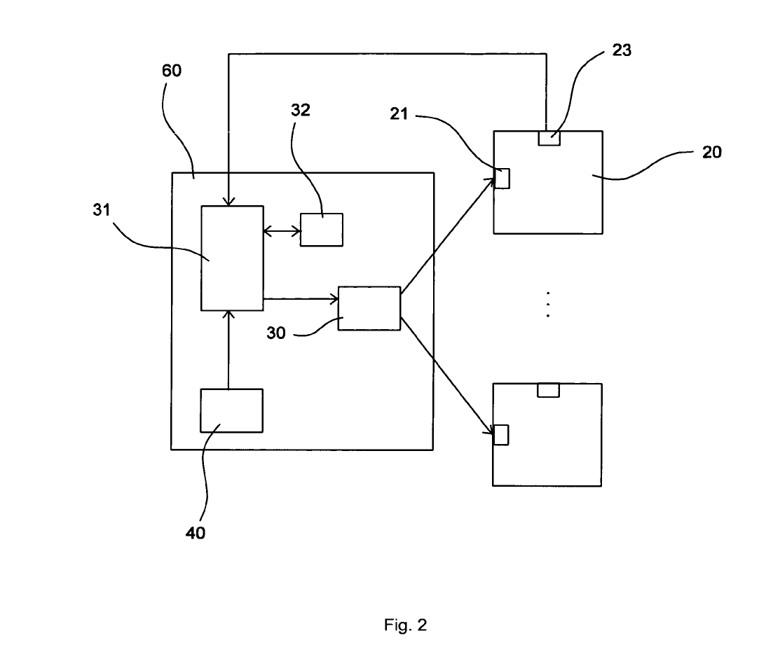

The operating unit is in communication with a data processing unit 31, as is schematically shown in FIG. 2. The data processing unit processes the information received by the operating unit and also makes information available that is to be relayed to a user of the deposit box facility via the operating unit. The data processing unit checks, for example, the access rights of users who enter an access code at the operating unit or who insert an ID card.

Preferably in the area of the operating unit 60, there is a central facility-detection device 40 having a device adapted to recognize and detect audio playback devices in a defined area around the facility-detection device 40. For this purpose, the facility-detection device 40 has at least one antenna and one circuit for transmitting and receiving data. If the deposit box facility is used, for example, as a deposit box facility for depositing and picking up parcels, then audio playback devices 50 are situated on the parcels 51 that are delivered through the modality of the deposit box facility.

The use of audio playback devices for designating parcels has the advantage that various types of data can be associated with the parcel and can be stored in the audio playback devices without this data having to appear on the shipment in plain text or, for example, as a barcode. The information can be read out at various stations along the transportation and distribution route of a parcel, a process in which data can also be deleted and/or augmented. Passive transponders without their own source of energy are preferably used in the realm of the designation of parcels.

The audio playback devices can be integrated into the packaging of the parcel or into a label that is applied onto the shipment. A label with audio playback devices can also be purchased and printed out at the deposit box facility. The data of the registered customer is automatically taken as the sender data. Data can be stored in the transponder by the sender of the parcel himself/herself, or else by a transportation and delivery company that deposits the parcel at a deposit box facility.

The sender and the recipient of a shipment, for example, can be stored in an audio playback device of a parcel. Moreover, it is advantageous to store an identification with which the shipment can be unambiguously identified within the parcel transportation and distribution system. This identification especially yields possibilities to track the parcel along the route from the sender to the recipient.

Preferably, the approximate dimensions of the shipment are stored in the audio playback device 50. The dimensions of parcels vary greatly, depending on the type of packaging that the sender has selected. In order to be able to associate the shipment with a postage charge, however, the dimensions can normally be categorized within certain size ranges on the basis of which the postage charge is then calculated. The calculation includes the dimensions as well as the weight of the shipment, so that the weight can likewise be stored in the audio playback device. Generally speaking, however, the weight is normally not decisive when it comes to selecting a suitable compartment of a deposit box facility.

The facility-detection device 40 is arranged in such a way that several transponders can detect and read out several parcels that are positioned by a deliverer in the vicinity of a deposit box facility 10, simultaneously preferably by bulk detection. Consequently, the facility-detection device 40 does not have to be directly on or in the operating unit 60 if this would have drawbacks for the transponder detection. The facility-detection device 40 should advantageously be positioned in such a way that a reliable detection of the transponders is ensured.

If a deliverer normally approaches a deposit box facility with a handcart containing all of the shipments intended for the deposit box facility, then the facility-detection device is advantageously arranged in such a way that all of the parcels located at the height of the loading platform of the handcart can be detected. In another exemplary embodiment of the invention, the deliverer can place the shipments onto a surface that is specially provided for this purpose and at which the-detection device is aimed. For example, a type of drawer or tray onto which the shipments can be placed can be pulled out of the operating unit 60.

The steps of a method according to an exemplary embodiment of the present invention are shown in the flow chart in FIG. 1. Before the deposit box facility is put into operation, the dimensions of the individual compartments have to be associated with the compartment identifiers of the compartments. In this process, advantageously, the width, height and depth of a compartment are ascertained and stored in the data processing unit 31.

When a deliverer places parcels in the vicinity of a deposit box facility, the facility-detection device 40 recognizes one or more audio playback devices situated in a defined area around the-detection device and reads out the data stored in these audio playback devices. The read-out data includes at least the dimensions of the individual parcels. For a more comprehensive detection and processing of data from audio playback devices, it is also possible, for example, to record the identification of a given audio playback device or of the object. The facility-detection device transmits this data to a data processing unit 31 as is shown schematically in FIG. 2. The data processing unit then ascertains the free compartments of the deposit box facility into which each individual parcel fits based on its dimensions.

The free compartments of the deposit box facility 10 can be ascertained in various ways by the data processing unit 31.

For example, the current occupation status of each compartment can be stored in the data processing unit. Once a parcel has been deposited into a compartment, this compartment is marked as being occupied. Once a shipment has been removed, the status of the compartment is changed accordingly and the compartment is marked as being free. The occupation status of each individual compartment can be stored in the data processing unit 31 of the deposit box facility 10 or in a remotely situated central data processing unit and can be requested from there.

In another exemplary embodiment of the invention, another compartment-detection device 23, comprising at least an antenna, is situated in each compartment of the deposit box facility. Each antenna is connected to a reading device. Another reading device is located, for example, in a control cabinet of the deposit box facility. A selection combinational circuit—which can also be called a multiplexer—is interconnected between the antennas of the compartments and the central reading device in the control cabinet. This circuit arrangement can ascertain from which compartment signals of audio playback devices are coming. The combinational circuit makes it possible to read out several compartments with one central reading device.

The compartment-detection devices 23 can be used to actively ascertain the current occupation status of the compartments of the deposit box facility at any point in time in that radio waves are emitted by the antenna of a compartment. In this manner, upon command, information can be read if a parcel with such an audio playback device is present in a compartment. The audio playback device receives the signal and, in response, sends the information stored in the audio playback device to the antenna of the compartment and thus to the central reading device.

Consequently, as soon as the dimensions of several parcels that are to be deposited into a deposit box facility have been ascertained by the data processing unit 31, an active query of the occupation status of the compartments can be made via the individual compartment-detection devices.

The possibility also exists for the occupation status of a compartment to be ascertained when changes occur in the status of the compartments. This occurs, for example, when a compartment is opened and closed again. Preferably when a compartment is closed, the antenna of the compartment sends a signal, and if an audio playback device can be detected and read out in the compartment, then the compartment is marked as being occupied. If no audio playback device can be detected, then the compartment is marked as being free. The occupation status can be stored in the data processing unit and can be requested from there.

Moreover, cyclical queries of the occupation status are possible. Thus, there are various ways to ascertain the occupation status of the compartments of a deposit box facility. In any case, the occupation status can be used by the data processing unit 31 to ascertain free compartments of a size into which the parcels that are to be deposited will fit based on their dimensions.

Each compartment preferably has an unambiguous compartment identifier, and the dimensions of the compartment in question are associated with said identifier. The associations of the compartment identifier with the dimensions are stored in the data processing unit 31. By comparing the dimensions of the parcels to the dimensions of the free compartments, the data processing unit ascertains the requisite compartments into which the parcels can be deposited. In this process, an algorithm stored in the data processing unit preferably always ascertains the smallest possible compartment into which a shipment can be deposited. If no free compartment having the right dimensions is available for a parcel, then this is displayed to the deliverer on the monitor.

The compartment identifiers of the free compartments into which parcels can be deposited are transmitted by the data processing unit 31 to a control unit 30, as is schematically shown in FIG. 2. Together with the identifiers, a command to open compartments is advantageously transmitted to the control unit. The control unit is configured in such a way that, through control signals, it actuates the locking mechanisms of the compartments and thus activates the opening and closing of the locks.

As soon as the control unit has received one or more compartment identifiers from the data processing unit as well as the command to open these compartments, said control unit generates and sends the requisite control signals to the compartments together with the compartment identifiers. The control signals can be generated and transmitted simultaneously or consecutively.

When the control signals are transmitted simultaneously, all of the actuated compartments open at the same time and the deliverer can deposit all of the shipments consecutively. When the control signals are transmitted consecutively to the locking mechanisms of the compartment doors, the compartments open consecutively and the deliverer can likewise deposit all of the shipments consecutively. In order to do so, the deliverer has to recognize which compartments are large enough, and then he/she places the shipments on the basis of his/her estimation. It can also be provided that the data processing unit has already associated specific compartments with the shipments and that these associations are displayed to the deliverer so that he/she can deposit the shipments in this specific manner. However, in order for this to be done, an identifier of each shipment has to be displayed to the deliverer, and the deliverer can obtain said identifier from the shipment.

For example, it can be provided that an unambiguous designation, which identifies the shipment for the deliverer, is applied onto an audio playback device label. This can be a sequence of numbers or letters that can be read off by the deliverer. The designation is likewise stored in the audio playback device of the object and is read out by the compartment-detection device. Once the data processing unit 31 has ascertained a free compartment of an appropriate size, the designation is associated with the compartment and can be displayed to the deliverer.

The designation can be shown to the deliverer, for example, on a display at the selected compartment. Moreover, a graphic representation of all of the compartments of the deposit box facility can be displayed on the monitor of the operating unit 60 and, for each compartment, it is also possible to display the designation of the parcel that fits into the compartment in question and that can consequently be deposited there.

If the compartments are opened consecutively, it can also be provided that the compartments open in the sequence of their size so that the deliverer can also select and deposit the parcels in the order of their sizes. For example, advantageously, first the smallest compartments can be opened, so that the deliverer deposits the smallest parcels in this order. Then each of the compartments of the next size are opened. This order of opening is especially advantageous if parcels are already stacked by the deliverer when he/she transports them to a deposit box facility, since the stack is normally such that smaller parcels are stacked on top of larger parcels.

In another exemplary embodiment of the invention, the audio playback devices of several parcels are detected simultaneously, but the deliverer has to subsequently once again detect the identifiers or designations of the individual shipments. For example, the data processing unit 31 associates the identifiers of the shipments with free compartments into which the shipments fit based on their dimensions. However, the compartments are not opened immediately. The deliverer has to once again detect the parcels, for example, via the audio playback device or via a supplementary barcode and only then does the compartment associated with the shipment open.

In another exemplary embodiment of the invention, the facility-detection device 40 detects only one audio playback device per parcel, and then the appropriate compartment for the shipment opens for the deliverer. The data read out of the audio playback device can be stored directly for the compartment, and all that the deliverer still has to do is to deposit the shipment.

In order to ensure that only shipments that have indeed been deposited are marked as having been deposited, it has proven to be advantageous for the deposition to be confirmed. This can be done, for example, in that the deliverer once again detects the transponder of the shipment using a compartment-detection device 23 or in that he/she pushes a confirmation button.

In an exemplary embodiment of the invention, not only objects with an audio playback device can be deposited, but shipments with other designations can likewise be deposited. If a deposit box facility is used, for example, by several transportation and delivery companies, the various companies can provide different designations for their shipments. In order to be able to deposit shipments of any kind, the deposit box facility can be equipped, for example, with a barcode scanner by which the data about shipments can be acquired if a shipment has a barcode but not an audio playback device.

Additional barcode scanners can also be used to be able to record and deposit shipments in case of a technical defect of a transponder or of a reading device.

The audio playback devices that can be integrated into the objects are, for example, music chips, for example, of the kind used in packets for transmitting pieces of music or text messages to users.

Exemplary embodiments of the present invention likewise encompass the transmission of audio data from a mobile user unit of a user.

Audio data can be transmitted from a mobile user unit to the deposit box facility, regardless of whether additionally the objects are also equipped with audio playback devices.

Advantageously, the audio data is played back in the form of an audio signal by a loudspeaker of the user device and can be received by a suitable receiving device—especially by a microphone or a sensor—of the deposit box facility.

According to an exemplary embodiment of the present invention, the audio data and thus preferably also the audio signals generated on its basis—preferably in a mobile user unit such as, for example, a mobile phone or a mobile digital assistant—can contain various items of information.

In particular, it is advantageous for the audio data to contain identification information.

The identification information serves, for example, to identify the user, or else the object or objects to be picked up. Furthermore, it is possible to use the identification information to associate users with user groups. For example, different user groups can be granted different rights for actions at the deposit box facility.

In order to simplify the operation of the deposit box facility, it is especially advantageous for control information to be associated with the audio data.

In an especially advantageous manner, this is done in that the control information is contained in the audio data or can be extracted from said audio data, if applicable, through decryption or through some other processing step.

The control information makes it possible to even further automate operating procedures at the deposit box facility.

A refinement of an exemplary embodiment of the present invention comprises a method for delivering a shipment to an electronic deposit box facility. This method is especially well-suited for facilitating pick-up by non-registered users.

This method may comprise the following steps:
depositing the shipment into a compartment of the electronic deposit box facility;
transmitting the audio data to the user and/or to a mobile user unit that he/she can use—for example, a mobile phone or other device that is suitable for playing back audio data;
picking up the shipment at the deposit box facility by a person, whereby
   at least the identifier associated with the recipient of the shipment is recorded,
   the identifier associated with the recipient of the shipment is compared to the identifier stored for occupied compartments, and
   the deposited shipment is released from a compartment if the result of the comparison indicates that the identifier associated with the recipient matches the identifier stored for the compartment in question.

### LIST OF REFERENCE NUMERALS

10 deposit box facility, parcel box unit
20 compartment
21 locking mechanism, lock
22 compartment door
23 compartment-detection device
30 control unit
31 data processing unit
32 storage means, memory
40 facility-detection device
50 audio playback device
51 object, mailpiece, parcel
60 operating unit

1-14. (canceled)

15. A deposit box facility for depositing objects into and/or picking up objects from the deposit box facility, the deposit box facility comprising:
an audio playback device;
a processor that is adapted to process audio data played back by the audio playback device and to identify an object present in the deposit box facility on the basis of the information acquired from the audio data; and
a device that is adapted to ascertain compartments of the deposit box facility in which there are no objects and to make a comparison of dimensions of the ascertained free compartments of the deposit box facility with object dimensions that have been received as part of the information acquired from the audio data.

16. The deposit box facility recited in claim 15, comprising a control unit that is adapted to generate a control signal.

17. The deposit box facility recited in claim 16, wherein the control unit is adapted to generate and/or transmit a control signal to a locking mechanism for opening a door associated with the object on the basis of a transmitted compartment identifier.

18. The deposit box facility recited in claim 15, comprising a compartment-detection device in at least one compartment of the deposit box facility, the compartment-detection device being adapted to detect an audio playback device situated in the compartment and to acquire data from the audio playback device, the compartment-detection device being further adapted to transmit the data read out of the audio playback device to the data processing unit, whereby the device that is adapted to ascertain compartments has a storage device that stores the data in order to identify the compartment in question.

19. The deposit box facility recited in claim 15, wherein additional information is associated with the audio data.

20. The deposit box facility recited in claim 15, wherein the audio data contains an audio barcode.

21. The deposit box facility recited in claim 15, wherein the audio data is embedded as an audio watermark into an audio signal.

22. The deposit box facility recited in claim 21, wherein the additional information is encrypted in such a way that it can be decrypted with a key that is present in a receiving device, and wherein the audio watermark contains the encrypted additional information.

23. A logistics system, comprising:
a deposit box facility for depositing objects into and/or picking up objects from the deposit box facility, the deposit box facility comprising:
an audio playback device;
a processor that is adapted to process audio data played back by the audio playback device and to identify an object present in the deposit box facility on the basis of the information acquired from the audio data; and
a device that is adapted to ascertain compartments of the deposit box facility in which there are no objects and to make a comparison of dimensions of the ascertained free compartments of the deposit box facility with object dimensions that have been received as part of the information acquired from the audio data.

24. The logistics system recited in claim 23, wherein the deposit box facility comprises a control unit that is adapted to generate a control signal.

25. The logistics system recited in claim 24, wherein the control unit is adapted to generate and/or transmit a control signal to a locking mechanism for opening a door associated with the object on the basis of a transmitted compartment identifier.

26. The logistics system recited in claim 23, wherein the deposit box facility comprises a compartment-detection device in at least one compartment of the deposit box facility, the compartment-detection device being adapted to detect an audio playback device situated in the compartment and to acquire data from the audio playback device, the compartment-detection device being further adapted to transmit the data read out of the audio playback device to the data processing unit, whereby the device that is adapted to ascertain compartments has a storage device that stores the data in order to identify the compartment in question.

27. The logistics system recited in claim 23, wherein additional information is associated with the audio data.

28. The logistics system recited in claim 23, wherein the audio data contains an audio barcode.

29. The logistics system recited in claim 23, wherein the audio data is embedded as an audio watermark into an audio signal.

30. A method for depositing objects into and/or picking up objects from a deposit box facility, the method comprising:
playing back audio data via an audio playback device to produce information;
identifying at least one object present in the deposit box facility on the basis of the information acquired from the audio data;
ascertaining the compartments of the deposit box facility in which there are no objects; and
comparing dimensions of the ascertained free compartments of the deposit box facility with object dimensions set forth in the information.

31. The method recited in claim 30, wherein the audio data contains control information for controlling the mechanisms of the deposit box facility.

32. The method recited in claim 31, wherein the control information is adapted to cause a door of the deposit box facility to open.

33. The method recited in claim 30, comprising linking control information to an identifier of the object identified in the audio data in such a way that a door associated with the object is opened.

34. The method recited in claim 30, comprising linking control information to an identifier of the object identified in the audio data in such a way as to control the conveyance of the object to a compartment that is suitable for removal later on.
